(19) United States
(12) Patent Application Publication
(10) Pub. No.: US 2020/0111141 A1
(43) Pub. Date: Apr. 9, 2020

(54) BUYER-SELLER VALIDATION AND COMMUNICATION PLATFORM

(71) Applicant: The Ant Hill Consulting Group, LLC dba: Ant Hill Retail, Provo, UT (US)

(72) Inventors: Jeremy Brockbank, Elk Ridge, UT (US); Brian Barnett, Bluffdale, UT (US)

(21) Appl. No.: 16/595,306

(22) Filed: Oct. 7, 2019

Related U.S. Application Data
(60) Provisional application No. 62/742,143, filed on Oct. 5, 2018.

(51) Int. Cl. G06Q 30/06; G06Q 30/00

(52) U.S. Cl. CPC G06Q 30/0609; G06Q 30/018

(57) ABSTRACT

The method includes performing a product search within a buyer-seller validation and communication platform, generating a search result comprising at least one product related to the product search, accessing a product listing on the buyer-seller validation and communication platform, the product listing corresponding to the at least one product, receiving an input from a buyer account providing an indication of buyer willingness to communicate with a seller account associated with the product listing, updating the seller account to allow the seller account to communicate with the buyer account within the buyer-seller validation and communication platform in response to the input from the buyer account indicating a positive buyer willingness to communicate with the seller account, and confirming restriction of communication by the seller account with the buyer account in response to the input from the buyer account indicating a negative buyer willingness to communicate with the seller account.

### CROSS-REFERENCES TO RELATED APPLICATIONS

This application claims the benefit of U.S. Provisional Patent Application No. 62/742,143 entitled “BUYER-SELLER VALIDATION AND COMMUNICATION PLATFORM” and filed on 5 Oct. 2018 for Jeremy Brockbank, et al, which is incorporated herein by reference.

### FIELD

This application relates to a validation and communication platform and more particularly relates to a buyer-seller validation and communication platform.

### BACKGROUND

In commerce, the ability to interact online has become critical. The variety and unparalleled access for consumers and sellers alike creates unique benefits and challenges.

### SUMMARY

A method is disclosed. The method includes performing a product search within a buyer-seller validation and communication platform, generating a search result comprising at least one product related to the product search, accessing a product listing on the buyer-seller validation and communication platform, the product listing corresponding to the at least one product, receiving an input from a buyer account providing an indication of buyer willingness to communicate with a seller account associated with the product listing, updating the seller account to allow the seller account to communicate with the buyer account within the buyer-seller validation and communication platform in response to the input from the buyer account indicating a positive buyer willingness to communicate with the seller account, and confirming restriction of communication by the seller account with the buyer account in response to the input from the buyer account indicating a negative buyer willingness to communicate with the seller account.

A platform for buyer-seller communication and program product also perform the functions of the method.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a block diagram of one embodiment of a supply network in accordance with the present invention;

FIG. 2 is a schematic diagram illustrating one embodiment of the validation and communication system of FIG. 1 in accordance with one embodiment of the present invention;

FIG. 3 is a block diagram illustrating another embodiment of the validation and communication platform of FIG. 1 in accordance with the present invention;

FIG. 4 illustrates a flow diagram of a buyer-side portion of the application in accordance with the present invention;

FIG. 5 illustrates a flow diagram of a seller-side portion of the application in accordance with the present invention;

FIG. 6 illustrates a flow diagram of a profile portion of the application in accordance with the present invention;

FIG. 7 illustrates a flow diagram of a profile viewing portion of the application in accordance with the present invention; and

FIG. 8 illustrates one embodiment of a method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network.

The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

The computer program product may be deployed by manually loading directly in the client, server and proxy computers via loading a computer readable storage medium such as a CD, DVD, etc., the computer program product may be automatically or semi-automatically deployed into a computer system by sending the computer program product to a central server or a group of central servers. The computer program product is then downloaded into the client computers that will execute the computer program product.

Alternatively, the computer program product is sent directly to the client system via e-mail. The computer program product is then either detached to a directory or loaded into a directory by a button on the e-mail that executes a program that detaches the computer program product into a directory. Another alternative is to send the computer program product directly to a directory on the client computer hard drive. When there are proxy servers, the process will, select the proxy server code, determine on which computers to place the proxy servers' code, transmit the proxy server code, then install the proxy server code on the proxy computer. The computer program product will be transmitted to the proxy server and then it will be stored on the proxy server.

The computer program product, in one embodiment, may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally, the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise, when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server, and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product.

Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

The computer program product, in one embodiment, may be deployed, accessed, and executed through the use of a virtual private network (VPN), which is any combination of technologies that can be used to secure a connection through an otherwise unsecured or untrusted network. The use of VPNs is to improve security and for reduced operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the computer program product (i.e. the software resides elsewhere) wherein the lifetime of the VPN is limited to a given period of time or a given number of deployments based on an amount paid.

The computer program product may be deployed, accessed, and executed through either a remote-access or a site-to-site VPN. When using the remote-access VPNs the computer program product is deployed, accessed, and executed via the secure, encrypted connections between a company's private network and remote users through a third-party service provider. The enterprise service provider (ESP) sets up a network access server (NAS) and provides the remote users with desktop client software for their computers. The telecommuters can then dial a toll-free number or attach directly via a cable or DSL modem to reach the NAS and use their VPN client software to access the corporate network and to access, download and execute the computer program product.

When using the site-to-site VPN, the computer program product is deployed, accessed, and executed through the use of dedicated equipment and large-scale encryption that are used to connect a company's multiple fixed sites over a public network such as the Internet.

The computer program product is transported over the VPN via tunneling which is the process of placing an entire packet within another packet and sending it over a network. The protocol of the outer packet is understood by the network and both points, called tunnel interfaces, where the packet enters and exits the network.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The description of elements in each figure may refer to elements of proceeding figures. Like numbers refer to like elements in all figures, including alternate embodiments of like elements.

Embodiments described herein relate to a buyer-seller validation and communication platform. Embodiments described herein are capable of improving interactions between two parties to a transaction. Embodiments of the platform include a validating process for one or both parties. The validating process determines a nature of a party through a series of queries as well as a variety of manual and/or automated investigations. Embodiments of the platform also provide filtering to allow at least one of a buyer and a seller to opt in to communication with the other while reducing the likelihood of scammers and other unwanted communications. Embodiments of the platform allow a user to open an account, validate the account, and communicate with matched counterparts.

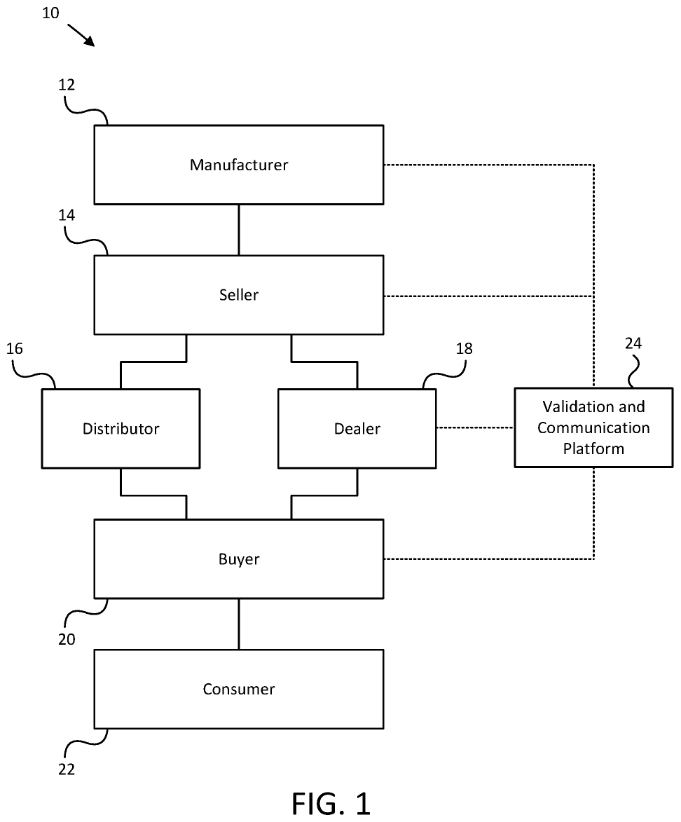

FIG. 1 illustrates a block diagram of one embodiment of a supply network 10. In the illustrated embodiment, a manufacturer 12 communicates with a seller 14. The manufacturer 12 may be a manufacturer of, for example, a physical or non-physical product, component of a product, or the like. The manufacturer 12 may also be a service provider. For example, the manufacturer 12 may be a service provider of professional services, software, digital services, or the like. In other words, the manufacturer 12 is a source of some good or service.

The seller 14 communicates with the manufacturer 12 to provide the goods and/or services of the manufacturer 12 to one or both of a distributor 16 and a dealer 18. The distributor 16 and/or dealer 18 then communicate with a buyer 20. The buyer 20 may be an online or brick-and-mortar retailer to whom an end consumer 22 comes to acquire the goods and/or services of the manufacturer 12. The retailer 20 communicates with the consumer 22 to supply the goods and/or services of the manufacturer 12 to the consumer 22.

In the illustrated supply network 10, each participant between the manufacturer 12 and the consumer 22 add cost and complexity. The complexity adds to the cost in time and effort to establish relations with reputable and reliable players in the supply network 10 and get the goods and/or services to the customer 22. The cost is passed along at each stage and is ultimately absorbed by the consumer 22. Furthermore, at each stage scammers or other nefarious parties may insert themselves and do damage to other parties in the transaction.

Embodiments described herein provide a validation and communication platform 24 which reduces the complexity and cost within the supply network 10. The validation and communication platform 24 facilitates communication between parties within the supply network 10. The validation and communication platform 24 further provides parties with the ability to view only those parties which are validated by the validation and communication platform 24 and approved by the user. The user, hereinafter, is described as the buyer 20. However, the validation and communication platform 24 may be used by any one of the parties within the supply network 10 to search for, and communicate with, other validated potential parties to the supply network 10. Additionally, embodiments of the validation and communication platform 24 facilitates new potential parties to become validated and be considered to participate in the supply network 10.

In some embodiments, the communication and validation platform 24 may facilitate removal of one or more of the parties in the illustrated embodiment of the supply network 10 to reduce the cost and complexity of the supply network 10. Furthermore, the communication and validation platform 24 may increase the efficiency of the supply network 10 by reducing the chance for scammers and other deceptions to occur, providing secure communication between parties, increasing trust and reliability between parties, establishing a history, disclosing information of interest, and the like.

In some embodiments, the validation and communication platform 24 validates a user. For example, a user may create a new account and log in to the validation and communication platform 24. The validation and communication platform 24 may perform a validation of the user and details associated with the user by requesting additional information. The validation and communication platform 24 may request the name of the company the user represents or with which the user is associated. For example, the validation and communication platform 24 may perform a search of known companies to identify a match with an entry provided by the user in response to a prompt. In some embodiments, the user selects the matching company or indicates that his/her company is not listed. If the user indicates that the correct company is not listed, the validation and communication platform 24 may prompt the user for additional information to create a new company entry. In some embodiments, the additional information includes at least one of a company name, a company type (buyer, seller, distributor, dealer, public relations, manufacturer, or the like), supply channel, number of employees, revenue, years in business, number of products offered, number of brands offered, website information, and the like.

In some embodiments, the information supplied by the user is stored and verified. The account may be listed as “verification pending” or the like. The validation and communication system 24 may initiate checks on the information provided by the user. The checks may be manual or automated. For example, the validation and communication system 24 may access and scan a website provided by the user or a support staff member may follow up with validating questions for the user or the company with which the user is associated. The validation and communication system 24 or a support staff member may search the business to verify a local or non-local status of the company. Because phone numbers and websites may be an inaccurate indication of location, brick-and-mortar locations may be verified. Links on websites may be verified as functional and websites may be checked for inconsistencies which may indicate fraud or lack of professionalism. Policy pages and payment systems may also be checked as an indicator of validity.

In some embodiments, the validation and communication system 24 may initiate a check of local, state, federal, or other registrations, licenses, or records. The registration of the website itself may also be checked. Other resources such as the Better Business Bureau, credit reporting agencies, search engines, customer reviews, and the like may also be considered.

In some embodiments, the user themselves may be validated. The validation of the user may include assessing the email address of the user and correlating it with the company to determine if the email address of the user is a business address of the company, making a phone call to the business number of the user to verify the number works and inquire about the user (current working status, location on the premise, and the like), requesting a validation action (ask the user to take and provide to the validation and communication system 24 a picture with a number of fingers held up and visible in the photo, hold up a note, take an image near signage for the company, or the like), if not available or if after hours, request a time when the user will be available for validation at the company.

In some embodiments, validation of the user and/or the company is necessary to access some of all of the features of the validation and communication system 24. For example, an account of a non-validated user may be marked as such during discussion with another user, in communications with the user, or when another user views the account of the non-validated user. In some embodiments, certain features of the validation and communication system 24 may be inactive or inaccessible to the user until validation is complete.

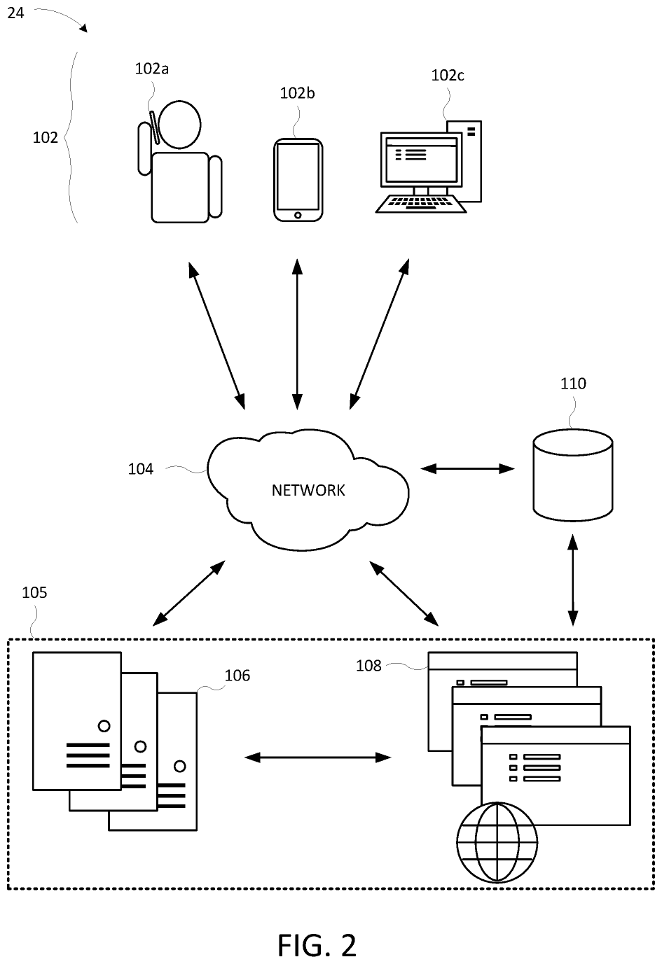

FIG. 2 is a schematic diagram illustrating one embodiment of the validation and communication system 24 of FIG. 1 in accordance with one embodiment of the present invention. In the illustrated embodiment, the validation and communication system 24 includes a user interface device 102 (depicted as a smart phone 102a, a tablet 102b, or a computer 102c).

In one embodiment, the user interface device 102 is a smartphone 102a. The smartphone 102a may execute an application local to the smartphone 102a or interface with an application at another location such as a server 106. For example, the user interface device 102 may access a web interface, an embedded application, a mobile or client application, etc. In another embodiment, the user may access the tablet 102b or the computer 102c (such as a desktop, laptop, terminal, or other computational device). In one embodiment, the user may establish an account, provide identifying information to log in to the account, validate a user identity, and validate a company or other entity associated with the user at the user interface device 102. The process of login, validation, searching, and the like are described in greater detail below.

The user interface device 102 is connected to a data network 104. In one embodiment, the user interface device 102 is connected to the data network 104 via a wired connection. In another embodiment, the user interface device 102 is connected to the data network 104 via a wireless connection. Various arrangements and embodiments of the data network 104 are described above. A party may interact with the data network 104 through the user interface device 102 to contact a communication and validation apparatus 105. In one embodiment, the communication and validation apparatus 105 includes one or more servers 106. In another embodiment, the communication and validation apparatus 105 includes one or more applications 108. In some embodiments, the server 106 interfaces with the application 108. For example, the application 108 may be executed on or by the server 106.

The application 108 may be executed locally on the server 106 or executed at a location remote to the server 106. The user interface device 102 may provide information, relating to the user account corresponding to the user, to the communication and validation apparatus 105 via the data network 104. In one embodiment, the communication and validation apparatus 105 receives the user account information. In another embodiment, the communication and validation apparatus 105 receives the information relating to the user account and accesses the user account based on this information. Greater detail on the information accessed by the communication and validation apparatus 105 is discussed below.

The communication and validation apparatus 105 accesses data from a data repository 110. In one embodiment, the data repository 110 is a network connected component. In another embodiment, the data repository 110 is an asset local to the communication and validation apparatus 105. The data repository 110 may also be located remote from the communication and validation apparatus 105.

In some embodiments, the data repository 110 is a public data repository. In other embodiments, the data repository 110 is a private data repository. In some embodiments, the data repository 110 may include a combination of private and public repository. The communication and validation apparatus 105 may access the data repository 110 based on the user account information. The data repository 110 may include structured or unstructured data or a combination of structured and unstructured data.

The communication and validation apparatus 105 receives a communication from the user interface device 102. The communication and validation apparatus 105 may compare the login information to information stored to the data repository 110 or elsewhere. For example, the login information may be stored to a dedicated repository, local to the user interface device 102, or on the server 106.

In response to correct login information, the communication and validation apparatus 105 may grant access to features of the application 108 associated with the user account and grant access to at least a portion of the data repository 110 for use by the user. The level of access granted may be based on validation status, historical data for the user, subscription level, relevant business areas, products offerings, supply network connections, actions of another user relative to the user's account, or the like.

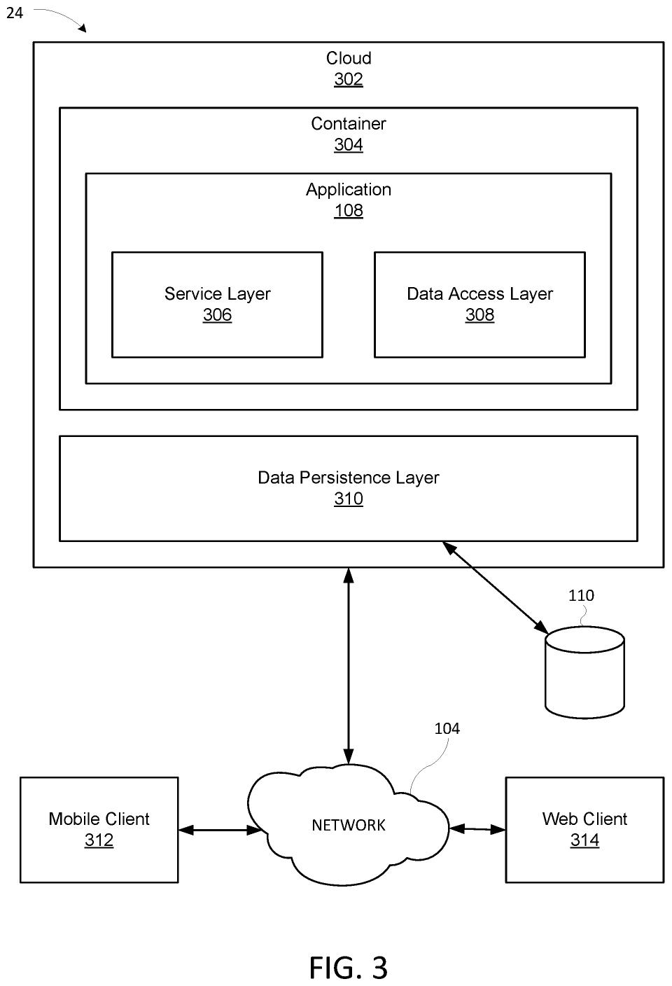

FIG. 3 is a block diagram illustrating another embodiment of the validation and communication platform 24 of FIG. 1. The illustrated embodiment of the validation and communication platform 24 is implemented using a cloud 302 computing resource. While the cloud 302 is shown, other distributed or non-distributed resources may be included.

The illustrated embodiment of the cloud 302 includes a container 304. In some embodiments, the container 304 is a data structure that forms an instance of one or more objects. The container 304 may facilitate storage, access, and/or traversal of the objects within the container 304. In some embodiments, the container 304 is a single-value container. A single-value container provides independent storage of the objects within the container 304. Alternatively, the container 304 may be an associative container. An associative container is constructed with arrays, lists, maps, dictionaries, or the like. The objects in the container 304 may be accessed by an iterator or directly. In some embodiments, the container 304 may facilitate object access through the use of a search tree or other referential construct.

In some embodiments, the objects support an application 108. As illustrated, the application 108 includes a service layer 306 and a data access layer 308. In some embodiments, the service 306 is configured to serve different application layers and facilitate other services carrying out business functions in the application 108.

The data access layer 308 may facilitate communication, for example by the service layer 306 of the application 108, with external data stores. For example, the data access layer 308 may abstract the data stores to ease the burden on other processes of the application 108. This may facilitate switching of various component types, for example, Oracle to MS SQL. The data access layer 308 may facilitate the decoupling of the service layer 306 from the data store, and structure of data within, to allow the service layer 306 to be agnostic of the logic of the data in the data store, such as the repository 110.

In the illustrated embodiment, the cloud 302 further includes a data persistence layer 310. In some embodiments, the data persistence layer 310 facilitates communication between the application 108 and the data repository 110. The data persistence layer 310 may facilitate reading and writing of data to and from the data repository 110 and objects of the application 108.

In the illustrated embodiment, the validation and communication system 24 also includes a mobile client 312. The mobile client 312 may communicate with the application 108 via the network 104. In some embodiments, the mobile client 312 communicates with the service layer 306. The mobile client 312 may facilitate communication of the user interface device 102 described above with regard to FIG. 2.

In some embodiments, the mobile client 312 facilitates a consistent experience between a plurality of user interface devices 102. In some embodiments, the mobile client 312, in combination with the application 108, may provide improved efficiency through division of labor, control of required calls (for example, API calls, user interface calls, or the like), version management, resource allocation, offline capabilities, error handling, security, data transmission, data storage, and the like.

The illustrated embodiment also includes a web client 314. Similar to the mobile client 312, the web client 314 may provide functionality with the application 108 via browser, portal, or other web interface. In some embodiments, the functionality provided by the web client 314 facilitates access to the application 108 via a user interface device 102.

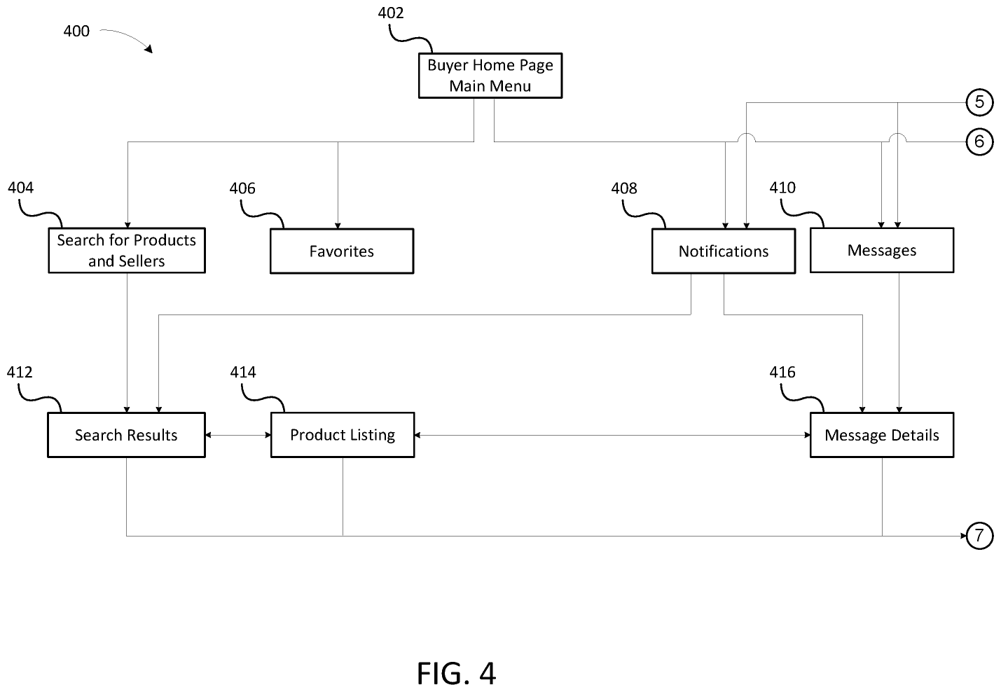

FIG. 4 illustrates a flow diagram of a buyer-side portion 400 of the application 108. In some embodiments, the application 108 may direct a user to a portion of the application 108 corresponding to a classification of the user. In the illustrated embodiment, the user is classified as a buyer. As a buyer, the user is presented with a corresponding set of menus and actions shown in FIG. 4 and described below.

In the illustrated embodiment, a buyer may be directed to a home page main menu 402. The buyer home page main menu 402 may allow for navigation throughout the application 108. In some embodiments, the buyer home page main menu 402 may be accessible from any point, stage, or page in the application 108.

From the main menu, the buyer may initiate a search for products and sellers 404, view favorites 406, receive one or more notifications 408, or access one or more messages 410. Each of these features is described in greater detail below.

The search for products and sellers 404 may allow buyers to search for products, sellers, and the like. In some embodiments, the search for products and sellers 404 may be filtered by search criteria. The search criteria may be pre-made or suggested criteria or may be criteria created and input by the buyer performing the search. In some embodiments, the search for products and sellers 404 may be pre-filtered by including the restrictions or limitations on the search prior to executing the search itself. In other embodiments, the search for products and sellers 404 is executed and the filtering or restricting options are made available for limiting provided search results 412.

In some embodiments, criteria for the search for products and sellers 404 include designating a search type. For example, the buyer may indicate that the search for products and sellers 404 be run seeking either a product or a seller. If the search for products and sellers 404 designates a product, additional options may be provided. The options for a product search 404 may allow a user to specify a channel (grocery, outdoor, sports, etc.), specify a category (firearms, fishing, camping, etc.), publish date (three months, six months, one year, etc.), seller rating, suggested retail price (upper bound, lower bound, average, current, etc.), minimum gross margin (percentage, number, etc.), and the like.

If the search for products and sellers 404 designates a seller, the options may include first name, last name, company name, location (zip code, city, state, country, continent, etc.), email address, website, brand name, phone number, and the like.

In some embodiments, the search for products and sellers 404 may require one or more of the options be selected prior to executing the search for products and sellers 404. In some embodiments, the options may be provided via dropdown menus, input fields, radio buttons, checkboxes, sliders, or the like. In some embodiments, minimum or suggested values may be provided by default or may be highlighted as common, popular, or relevant query filters or options. Other forms of ranking or sorting the available options may be employed.

Viewing favorites page 406 may include providing a list of products and/or sellers that the buyer has marked as favorites. Similar to the search page 404 above, the favorites page 406 may be sorted, filter, organized, or otherwise modified to present the desired information. In some embodiments, the favorites page 406 list may be navigated by page up/down, scrolling, swiping, and other navigation inputs. Other options may be available to the user including removing a product or seller from the favorites page 406 or accessing data corresponding to a selected favorite in response to a click, tap, swipe, or other selection input. For example, selection of a favorite may display the product listing or seller page corresponding to the selected favorite.

In some embodiments, the favorites are compiled based on a positive user input selecting a product or seller as a favorite. In other embodiments, a seller or product may be designated as a favorite or potential favorite based on historical data of the user (frequency of views, favorites of similar products/sellers, communications with a seller or regarding a product, etc.).

In some embodiments, the notifications 408 are also made available to the user. The notifications 408 may include an indicator. In some embodiments, the notifications 408 may be accessed from a portion of the main menu 402, which may provide access to all pending or current notifications 408 for the user. The notifications 408 may be filtered or sorted by default or based on user input. The user may elect to see only unread notifications 408, only notification pertaining to a certain product/seller or group of products/sellers. Other functionality such as marking notifications 408 as read or unread, deleting or saving notifications 408, blocking notifications 408 from a specific source, or opening a notification 408 may be included. Other settings and preferences may also be provided.

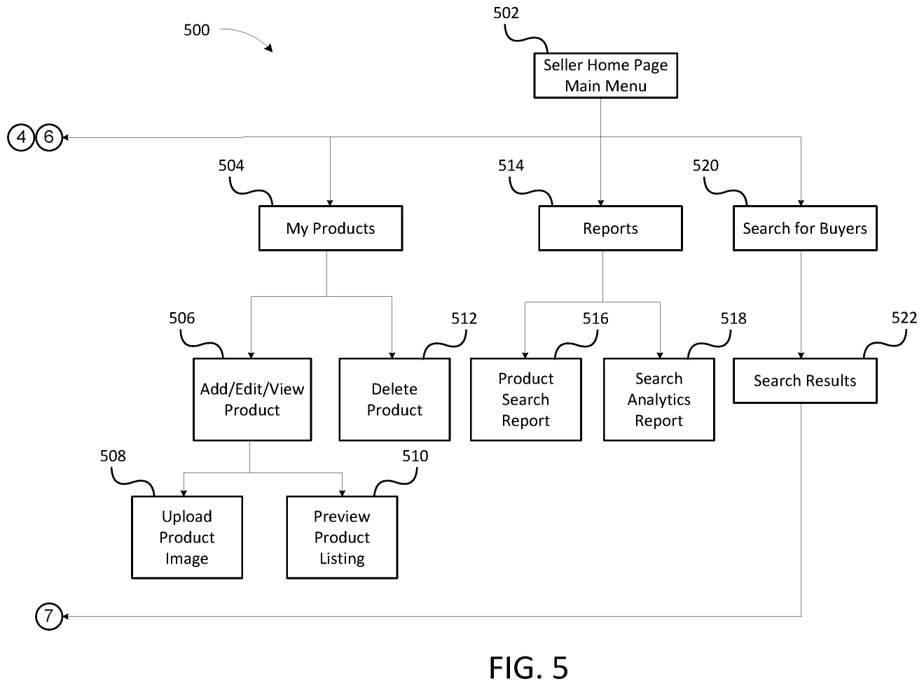

In the illustrated embodiment, one or more notifications 408 may be provided by the seller as described below regarding FIG. 5. For example, a message 410 from a seller may trigger a notification 408 for the buyer. Other triggers, such as profile views, being identified as a favorite, error messages, etc. may also generate notifications 408.

The illustrated embodiment also includes a place for the buyer to access messages 410. Messages 410 may include a list of all in-platform messages corresponding to the account of the user. The messages 410 may include system messages regarding events corresponding to the account of the user and/or messages from other users, such as sellers or other buyers. In some embodiments, the messages 410 also allows the user to respond to or generate messages 410.

In some embodiments, the platform 24 facilitates the sending of messages 410 from one user to another wholly within the platform 24. In some embodiments, the ability to send messages 410 to another user is dependent upon one or more characteristics of the account that is sending or receiving the message 410. For example, a limitation on sending or receiving may be based on a user's rating, tier, personal message settings, or the like. The user's rating may be based on historical data for the user. For example, the user may have negative or positive reviews from other users based on previous interactions with those users. The tier of the account may be based on an amount of time the account has been active, a reaching a certain rating, purchasing a paid subscription or membership, or the like. Personal message settings for a user may prevent messages 410 from being sent to or received from accounts based on certain criteria such as favorite status, validated account, channel/product/margin details, or the like.

As mentioned, sending or receiving a message 410 may generate a notification 408. The notification 408 may be provided to a mobile device or other user device to communicate to the user that a message has been received.

In some embodiments, the message 410 may be a written message. The message 410 may include images, links, audio, video, or the like. The message 410 may be an instant message or follow the style of an email. The message 410 may indicate the sender/recipient. The message 410 may include or omit a subject line/title/header/synopsis or the like.

In the illustrated embodiment, the buyer-side portion 400 of the application 108 includes search results 412, product listing 414, and message details 416. The search results 412 may display the results of a product or seller search 404 performed by a buyer. This page may also be used to display the products for which the buyer has received notifications 408 or to display sellers from whom the buyer has notifications 408. In some embodiments, the search results 412 provides a connecting point between buyers and sellers.

In some embodiments, the application 108 provides an intuitive user interface for buyers to assign a status to a seller appearing in the search results 412. For example, based on a swipe, click, keystroke, or other input, a buyer may indicate a desire or willingness to communicate with a seller. Additionally, a slightly different input may signal a lack of desire or unwillingness, on the part of the buyer, to communicate with the seller. In some embodiments, other inputs may provide intermediate indications such as a time-limited willingness to receive communications, a conditional indication (I will communicate with you if you X, Y, Z), or other limited or intermediate indications. In some embodiments, the indications may be displayed via the use of a “green light” (permission to communicate), a “red light” (disallow communication), a “yellow light” (time-based or otherwise limited communication, or the like.

In some embodiments, the action by the buyer to facilitate or disallow communication may be made at a seller profile. In other embodiments, the action by the buyer may be made on a product listing 414 of the seller.

The product listing 414 may include some or all of the details relating to a product. The product listing 414 may appear as a result in the search results 412 or may be accessible from a seller profile or other source such as a message 410 or notification 408.

In some embodiments, one or more actions are available to the buyer with respect to the product listing 414. For example, the buyer may be able to access the seller profile from the product listing 414, flag the product as miscategorized or spam, share the product listing 414, return to the search results 412 or message 410, and favorite the product listing 414 or seller, or the like.

The illustrated message details 416 may be reached through at least one of the notifications 408 and the messages 410. The message details 416 displays all the details regarding a selected message 410. From the message details 416, a buyer may be given the option to, at least one of, view the corresponding seller profile, message the seller, view the product listing 414 for a product corresponding to the message 410, flag the message 410 as spam or undesired communication, and remove the seller and/or product from the favorites 406 of the buyer.

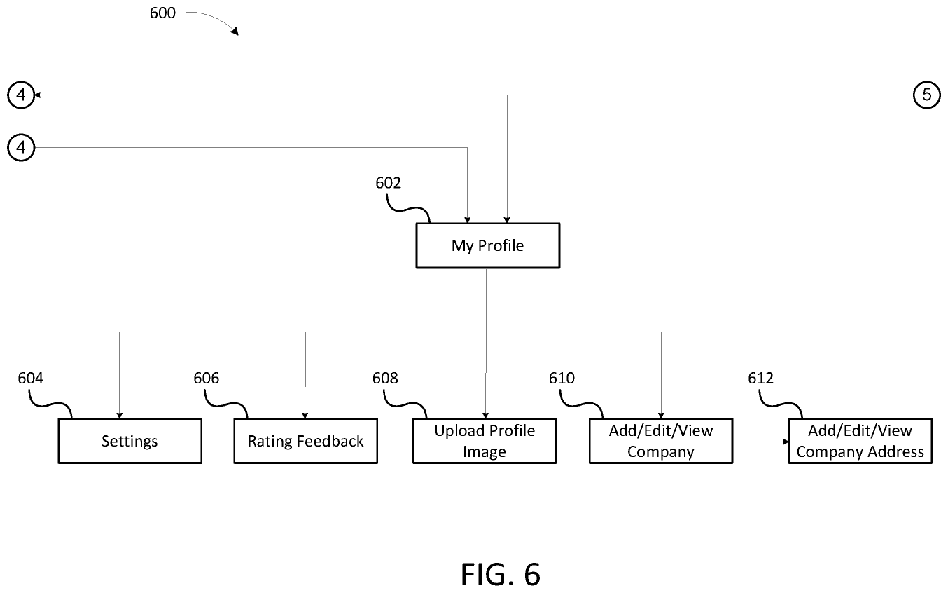

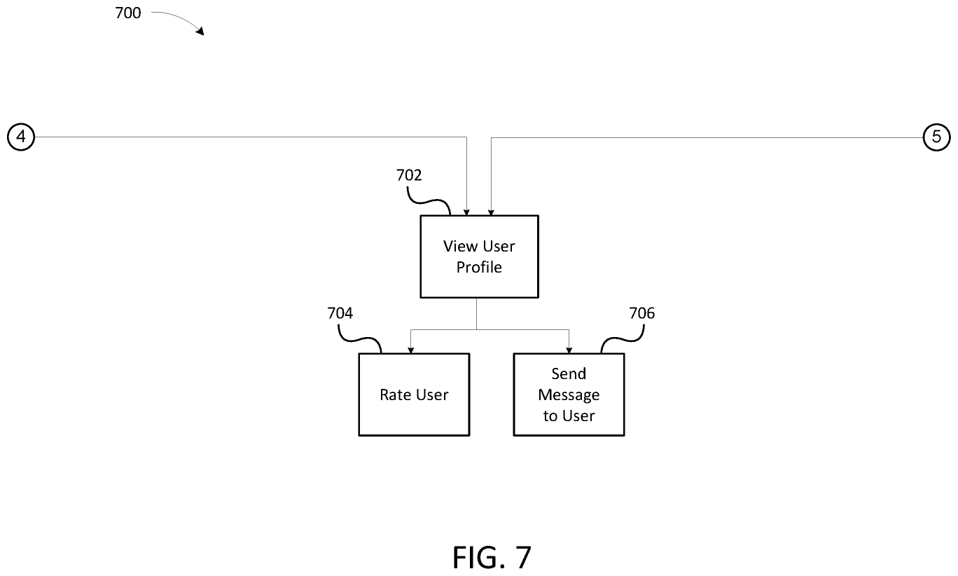

As illustrate in FIG. 4, the buyer may navigate from at least one of the search results 412, the product listing 414, and the message details 416 to the user profile 702 shown in FIG. 7 and described below. Additionally, the buyer may navigate from the home page/main menu 402 to a My Products page 602 shown in FIG. 6 and described below.

FIG. 5 illustrates a flow diagram of a seller-side portion 500 of the application 108. The illustrated embodiment includes a seller home page main menu 502. The seller home page main menu 502 may be displayed in response to a log-in of a user identified as a seller. The seller home page main menu 502 may provide functionality to navigate through at least a portion of the application 108 available to the seller. The seller home page main menu 502 may make accessible a plurality of actions. In some embodiments, the seller home page main menu 502 is accessible to the seller from any page in the application 108.

The illustrated embodiment of the seller-side portion 500 also includes a My Products page 504. The My Products page 504 may allow a seller to see products that the seller has uploaded to the platform 24. The My Products page 504 may allow a seller to sort or filter the products on the My Products page 504. For example, the seller may sort the list by data added, channel, or other status such as published, unpublished, deleted, or the like.

If the seller selects a product from the My Products page 504, the seller may be directed to an Add/Edit/View Product page 506. The Add/Edit/View Product page 506 may allow the seller to make modifications to the My Product page 504 or to specific product listings in the My Product page 504. For example, the seller may add a new product, may edit an existing product, or view the current product details. When editing a product, the seller may be provided with a plurality of editable fields corresponding to the product. For example, the fields may include a title, channel, category, description, suggested retail price, gross margin, dimensions, weight, model number, warranty, features, specifications, included components, status, or the like. One or more of the editable fields may be free-form editable, drop down menu with pre-populated options, radio buttons, sliders, or the like.

In some embodiments, the seller may be prompted or allowed to upload images corresponding to the product. For example, the seller may select from a local or remote gallery accessible by the platform 24, may upload an image directly from a camera or other storage device, may select an image repository not corresponding directly with the platform 24, or the like.

If the seller elects to upload a product image, the application 108 may navigate the seller to an upload product image page 508. The upload product image page 508 may display the details corresponding to the product on the upload product image page 508 and provide a navigation tool to facilitate upload of the product image from a storage location local or remote to the application 108. The tool may facilitate browsing available resources or establishing a connection to provide one or more images to the upload product image page 508.

The seller may also elect to preview the product listing from the Add/Edit/View Product page 506. In response to an election to preview the product, the application 108 may direct the seller to a preview product listing page 510. In some embodiments, the preview product listing page 510 allows the seller to see how the product listing looks to a buyer, if the product is currently published, or to see how the product listing will look once an unpublished listing is published.

In some embodiments, the preview product listing page 510 may present the preview to the seller within the context of a product search list in a preview mode. In other words, the preview mode may show the product preview as it would be seen by a buyer in a search results 412 after performing a product search 404. In some embodiments, the seller may be able to navigate into the product listing from the search results 412 by selecting the previewed product listing from among the search results 412. In some embodiments, while some functionality of the preview mode is identical to a non-preview navigation of the associated pages, some functionality of the preview mode at the search results 412 and product listing 414 pages is limited. For example, selecting some options may generate a tooltip or other message describing what would happen were the seller or a buyer to select the corresponding function outside of the preview mode. More or less functionality may be provided while in the preview mode through the preview product listing page 510.

As further illustrated in FIG. 5, the seller may also select, at the My Products page 504, a delete option corresponding to the product from a listing in the My Products page 504. In response to selection of the delete option, the seller may be directed to a delete product page 512. The delete product page 512 may allow the seller to delete the product from the product listing associated with the seller. In some embodiments, the delete product page 512 may prompt the seller to provide a reason for deletion of the product.

From the seller home page main menu 502, the seller may also access a reports page 514. The reports page 514 may display one or more reports available to the seller. The reports page 514 may provide reports on the product, seller, buyer, channel, category, or the like. The reports on the reports page 514 may be sorted or filtered in response to input from the seller.

In some embodiments, the reports page 514 may display a search report for a product. Accessing the search report for the product may direct the seller to a product search report 516. In some embodiments, the product search report 516 provides data on a number of searches in which the product appeared, how many positive reactions were given by buyers, how many negative reactions were given by buyers, reasons for positive or negative reactions, or the like. The product search report 516 may include a table, graph, chart, list, or the like. In some embodiments, the buyer may also leave a comment which may be shown in a separate or integrated comment portion of the product search report 516.

The reports page 514 may also provide analytics to the seller. In the illustrated embodiment, the reports page 514 directs the seller to a search analytics report page 518. In some embodiments, the search analytics report page 518 provides information to the seller regarding search parameters used by buyers in searching products and sellers. For example, the search analytics report page 518 may list or otherwise describe the criteria and may also provide a number of times each criterion was used to perform a search. In some embodiments, the seller may drill down by selecting one or more criteria to view the number of buyers that utilized the selected criteria to perform searches and further provide access to view the profiles of the corresponding buyers. Other drill downs and information may be made accessible via the search analytics report page 518.

In the illustrated embodiment, the seller may also access a search for buyers page 520 from the seller home page main menu 502. The search for buyers page 520 may provide sellers with a search tool for identifying buyers. The seller may select or enter one or more criteria to limit or filter the search. In some embodiments, the search may be limited based on a qualification, validation, or other characteristic of the seller or seller account. For example, the seller may be limited based on a rating of the seller, a validation of a company or other entity of the seller, a tier level of the seller or associated entity, a message setting of the buyer corresponding to the search, or the like. For example, a new seller may not be able to instantly gain access to all the buyers of prestigious or upper tier buyers. In some embodiments, the buyers from the upper tier may be able to contact or view the new seller but the new seller would be restricted until the qualifications of the seller are compatible with the target buyer.

In some embodiments, the search run on the search for buyers page 520 may facilitate entry of various search terms which may be pre-populated or free-form entry. For example, the search terms may include the buyers first name, last name, company name, email, channel, category, job title, or the like.

In response to performing the search at the search for buyers page 520, the seller may be directed to a search results page 522. The search results page 522 may provide the search results in a sortable and/or filterable presentation. As described above, the search may be limited by seller rating, seller company rating, buyer settings, and the like.

From the search results page 522, the seller may navigate to a view user profile page 702 shown in FIG. 7 and described below. In the illustrated embodiment, the seller home page main menu 502 may also facilitate access to the notification page 408 and the messages page 410 shown in FIG. 4 and described above. Furthermore, the seller home page main menu 502 may facilitate access to a My Profile page 602 shown in FIG. 6 and described below.

FIG. 6 illustrates a flow diagram of a profile portion 600 of the application 108. In the illustrated embodiment, a user (for example, a seller or a buyer) may navigate to a My Profile page 602 from a buyer home page main menu 402 or a seller home page main menu 502.

On the My Profile page 602, the user may edit personal information that forms part of the personal profile of the user. In some embodiments, the user may provide information to fill out the profile. The information may include at least one of a salutation (Mr., Mrs., Miss, etc.), first name, last name, email, username, phone number, company name, company phone number, company address, job title, profile image, and the like.

In some embodiments, the My Profile page 602 also displays information for the user such as a status of the account of the user, a rating of the user, a sign-up date of the user, a role of the user (buyer/seller), a security question associated with the account, or the like. In some embodiments, the My Profile page 602 may provide tooltips regarding the information for the user which gives context and description for each element.

In the illustrated embodiment, the user can navigate to a setting page 604. The setting page 604 allows the user to view and modify one or more settings for the associated account. For example, the setting page 604 may allow a user to select a corresponding profile setting or determine a notification setting. In some embodiments, the setting page 604 may allow a user to specify what personal information the user would like to make publicly available via profile. The user may also determine how messages and notifications are delivered or presented to the user.

As illustrated, the user may also navigate to a rating feedback page 606. The rating feedback page 606 may allow the user to view all rating feedback received from other users. In some embodiments, the rating feedback page 606 may communicate to a user a number of spam and miscategorized records are associated with the user account. In some embodiments, the rating feedback page 606 provides an opportunity for the user to respond to any feedback that the user has received. For example, the rating feedback page 606 may allow a user to make a comment on the feedback, ask a follow-up question to the source of the feedback, offer a solution to negative feedback, message a source of the negative feedback, or the like. In some embodiments, the rating feedback page 606 also provides a record of feedback provided by the user relative to other users and products on the platform 24.

The user may also navigate, from the My Profile page 602, to an upload profile image page 608. From the upload profile image page 608, the user may provide a profile image to be associated with the user account. The user may be able to select from default images, user uploaded images, past profile images, or navigate to new profile images local or remote to the platform 24.

The user may also navigate to an add/edit/view company page 610. The add/edit/view company page 610 provides the user with controls to manage a company record with which the user is associated. For example, when a user is first added to the platform 24, the user may not be associated with a company. After creating an account, the user can then specify the company with which the user is associated. In some embodiments, company records are shared among users to allow employees or agents of the same company to be linked to the same company record. In some embodiments, if the user selects an existing company with which to be associated, a vetting process is implemented to verify that the user has a legitimate connection with the company.

In some embodiments, the add/edit/view company page 610 provides a search feature to allow a user to search for existing company profiles by company name, type, channel, or the like. As a result of the company search, the user may be provided with the tier, rating, address, and the like. In some embodiments, the user may discover that the desired company is not found. In this case, the user may add the company by provided requested information and validating the company. The company may be validated through one or more requests made by the platform 24.

Similarly, the user may navigate to an add/edit/view company address page 612. The user may provide more concise or correct information relating to a company address through the add/edit/view company address page 612. In some embodiments, a user may correct a duplicity in the address associated with a company. In some embodiments, the user may clarify multiple locations associated with different facilities of the same company. Other options to remedy errors or inconsistencies may be provided through the add/edit/view company address page 612.

FIG. 7 illustrates a flow diagram of a profile viewing portion 700 of the application 108. In the illustrated embodiment, the buyer may be brought to a view user profile page 702 from the search results page 412 or the message details page 416 of the buyer-side portion 400 shown in FIG. 4 and described above. Additionally, the seller may navigate to the view user profile page 702 from the search results page 522 of the seller-side portion 500.

The view user profile page 702 may display a public profile of a user to another user. As described above, the public profile of a user may include at least one of a salutation, name, company name, sign-up date, profile image, status, rating, tier, and the like. Some profiles may not be available for viewing for some users based on profile settings, status, channel, or tier discrepancies, or the like.

The user viewing the profile on the view user profile page 702 may also perform a rate user 704 action on each profile. In some embodiments, the action to rate the user may be selection of a value (1, 2, 3, 4, 5, A, B, C, D, or the like) or a descriptor such as “good,” “bad,” “timely,” untimely,” or the like. In some embodiments, the user leaving the rating may also provide a reason. The reason may be a hard-coded or pre-populated answer that may be selected by the user leaving the rating. In some embodiments, a free-form text entry field may be provided to supply a reason for a given rating.

In the illustrated embodiment, the user may also navigate from the view user profile page 702 to a send message to user page 706. From the send message to user page 706, the user may create and send a message to the user corresponding to the profile page. In some embodiments, the message may be a predetermined phrase such as “I'm interested in connecting. Let's talk” or the like. In some embodiments, the message may be a free-form text entry field allowing the message writer to compose a personal message to the recipient. As described above, the user may be restricted from contacting the profile owner based on user rating, settings, user tier, user level (for example, paid/unpaid), or the like.

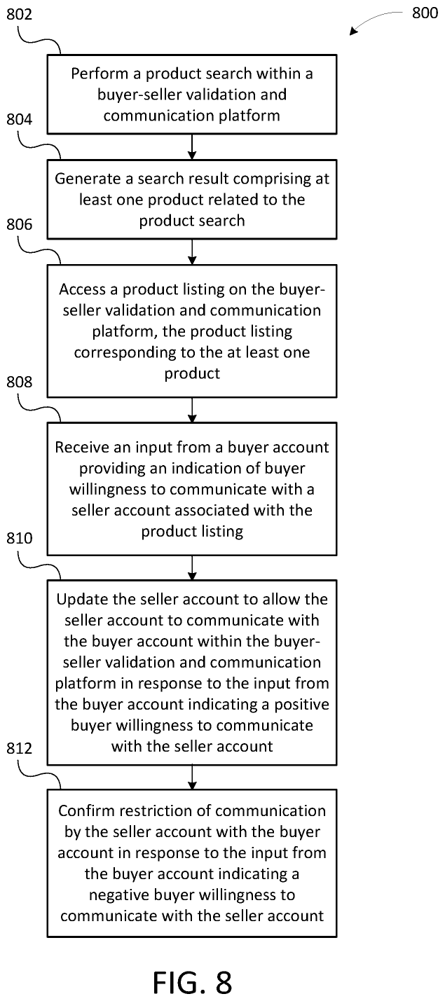

FIG. 8 illustrates one embodiment of a method 800. The method 800 includes, at block 802, performing a product search within a buyer-seller validation and communication platform. The method 800, at block 804, includes generating a search result comprising at least one product related to the product search. The method 800, at block 806, includes accessing a product listing on the buyer-seller validation and communication platform, the product listing corresponding to the at least one product. The method 800, at block 808, includes receiving an input from a buyer account providing an indication of buyer willingness to communicate with a seller account associated with the product listing. The method 800, at block 810, includes updating the seller account to allow the seller account to communicate with the buyer account within the buyer-seller validation and communication platform in response to the input from the buyer account indicating a positive buyer willingness to communicate with the seller account. The method 800, at block 812, includes confirming restriction of communication by the seller account with the buyer account in response to the input from the buyer account indicating a negative buyer willingness to communicate with the seller account.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
performing a product search within a buyer-seller validation and communication platform;
generating a search result comprising at least one product related to the product search;
accessing a product listing on the buyer-seller validation and communication platform, the product listing corresponding to the at least one product;
receiving an input from a buyer account providing an indication of buyer willingness to communicate with a seller account associated with the product listing;
updating the seller account to allow the seller account to communicate with the buyer account within the buyer-seller validation and communication platform in response to the input from the buyer account indicating a positive buyer willingness to communicate with the seller account; and
confirming restriction of communication by the seller account with the buyer account in response to the input from the buyer account indicating a negative buyer willingness to communicate with the seller account.

2. The method of claim 1, wherein the input from the buyer comprises a swipe input, wherein a swipe in a first direction indicates the positive buyer willingness to communicate with the seller and a swipe in a second direction indicates the negative buyer willingness to communicate with the seller account.

3. The method of claim 1, wherein updating the seller account to allow the seller account to communicate with the buyer account comprises allowing the seller account to communicate with the buyer account for a time-limited duration.

4. The method of claim 1, further comprising performing a company validation, the company validation comprising at least one of determining a company type, determining a number of employees, determining gross revenue, determining a number of years in business, determining a number of products offered, determining a number brands offered, determining a location, analyzing a company website, determining a business registration status, determining offered payment systems, and determining a credit rating.

5. The method of claim 4, wherein a status is listed as pending prior to satisfaction of the company validation.

6. The method of claim 4, providing access to at least one feature of the buyer-seller validation and communication platform in response to satisfaction of the company validation.

7. The method of claim 1, further comprising classifying a user and performing the search based on a classification of the user.

8. The method of claim 1, further comprising receiving a favorite designation and storing a corresponding buyer or seller account as a favorite and displaying the favorite on a favorites page.

9. The method of claim 1, further comprising providing a notification in response to receiving the input from the buyer account providing the indication of buyer willingness to communicate with the seller account associated with the product listing.

10. The method of claim 1, further comprising determining a subscription level to provide access to features of the buyer-seller validation and communication platform.

11. The method of claim 1, wherein updating the seller account to allow the seller account to communicate with the buyer account further comprises applying a green light status to the seller account.

12. The method of claim 1, wherein confirming restriction of communication by the seller account with the buyer account comprises applying a red light status to the seller account.

13. The method of claim 1, further comprising providing a message to the buyer account indicating interest from a seller account to allow the seller account to communicate with the buyer account, the message providing response options selectable by the buyer account.

14. The method of claim 1, further comprising allowing the seller account to upload information relating to product to a product page.

15. A platform for buyer-seller communication and validation comprising:
a computing resource to implement an application configured to:
perform a product search within the buyer-seller validation and communication platform;
generate a search result comprising at least one product related to the product search;
access a product listing on the buyer-seller validation and communication platform, the product listing corresponding to the at least one product;
receive an input from a buyer account providing an indication of buyer willingness to communicate with a seller account associated with the product listing;
update the seller account to allow the seller account to communicate with the buyer account within the buyer-seller validation and communication platform in response to the input from the buyer account indicating a positive buyer willingness to communicate with the seller account; and
confirm restriction of communication by the seller account with the buyer account in response to the input from the buyer account indicating a negative buyer willingness to communicate with the seller account;
a network interface to provide connectivity for the computing resource to a network; and
at least one of a mobile client and a web client coupled to the network to allow the seller account and the buyer account to interface with the application.

16. The platform of claim 15, wherein the application is further configured to update the seller account to allow the seller account to communicate with the buyer account by applying a green light status to the seller account.

17. The platform of claim 15, wherein the application is further configured to update the seller account to disallow the seller account to communicate with the buyer account by applying a red light status to the seller account.

18. A program product comprising a non-transitory computer readable storage medium that stores code executable by a processor to:
perform a product search within a buyer-seller validation and communication platform;
generate a search result comprising at least one product related to the product search;
access a product listing on the buyer-seller validation and communication platform, the product listing corresponding to the at least one product;
receive an input from a buyer account providing an indication of buyer willingness to communicate with a seller account associated with the product listing;
update the seller account to allow the seller account to communicate with the buyer account within the buyer-seller validation and communication platform in response to the input from the buyer account indicating a positive buyer willingness to communicate with the seller account; and
confirm restriction of communication by the seller account with the buyer account in response to the input from the buyer account indicating a negative buyer willingness to communicate with the seller account.

19. The program product of claim 18, wherein the code is further executable by the processor to providing a message to the buyer account indicating interest from a seller account to allow the seller account to communicate with the buyer account, the message providing response options selectable by the buyer account.

20. The program product of claim 19, wherein the code is further executable by the processor to detect a swipe input from a buyer account corresponding to the interest from the seller account, wherein a swipe in a first direction indicates the positive buyer willingness to communicate with the seller and a swipe in a second direction indicates the negative buyer willingness to communicate with the seller account.
